(19) United States
(12) Patent Application Publication
(10) Pub. No.: US 2019/0147406 A1
(43) Pub. Date: May 16, 2019

(54) Interview Scheduler

(71) Applicant: Michael Olufemi Awotedu, Austin, TX (US)

(72) Inventor: Michael Olufemi Awotedu, Austin, TX (US)

(21) Appl. No.: 15/809,274

(22) Filed: Nov. 10, 2017

(51) Int. Cl. G06Q 10/10

(52) U.S. Cl. CPC G06Q 10/1053; G06Q 10/1095

(57) ABSTRACT

The invention is an interview scheduling method and system for producing a customizable, multi-candidate interview schedule. The system includes an interface adapted to accept at least one manually entered configuration parameter from a recruiter into the memory, and a central processing unit comprising means for creating a programmatic logic table based upon the configuration parameters. The programmatic logic table is adapted to accept at least one specific data defined by the configuration parameters into a plurality of data cells, each including a single data type and having unique compatibility markers attached thereto, the markers being configured for specified compatibility with each other based upon the configuration parameters. A means for associating the data using the compatibility markers produces a real-time calendar that is unique to the employment opening.

### CROSS-REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM

Not applicable.

### STATEMENT REGARDING PRIOR DISCLOSURES BY THE INVENTOR OR A JOINT INVENTOR

Not applicable.

### BACKGROUND OF THE INVENTION

### Field of the Invention

Filling an employment position typically includes determining the type of evaluation necessary to find and acquire the right talent. Generally, interview criteria are set, one or more meetings between multiple candidates and multiple interviewers for a position are set. The interviewers are commonly selected to interview candidates and to determine whether the candidate's experience and skins in specific areas, work history, availability, and the personal attributes match those being sought out by the entity.

Coordinating and scheduling the employees or interviewers to conduct interviews in a way that schedules the most appropriate person for the type of interview to be conducted can be challenging. In order to ease the scheduling burden companies may employ a dedicated human resource professional or a recruiting coordinator.

This invention is related to a system for scheduling interviews or appointments through the use of a series of programmatic logic, a configuration form, automation, and a cloud based real-time calendar.

### Description of Related Art

There are devices, programs, and methods for scheduling employment interviews. U.S. Pat. Nos. 9,397,803 B2, 9,117,201 B2, 7,181,317 B2, 7,991,635 B2, 6,618,734B1, US20040186743A1, and US20070088601A1 all disclose scheduling methods and systems. However, none of them solve the problems addressed by the present invention. Prior art systems and methods mostly act as automated matching programs, that blindly pull from integrated calendars to schedule one candidate with one interviewer without any specific selection criterion. As such, each candidate and interviewer must be matched up by a recruiter. Others are directed to interview simulations.

The problem this invention solves is that of time spent scheduling interviews for multiple candidates and multiple interviewers. Existing systems email participants in bulk, which allows candidates to be the driver of the interview schedule. This can be chaotic as the interview process has precise interview stages and often requires meetings with multiple types and levels of interviewers.

The current systems and methods allow the interviewers to drive the candidate schedule according to certain parameters developed based upon a specific job available, not the candidate. Once a recruiter enters the configuration parameters specific to the position, including the time frame, interview stage, and available interviewers, the system will automatically create a programmatic logic table that is adapted for the specific job. Once the table is configured, the system will automatically create a calendar driven by the logic table, that includes blocks of time. Interviewers that meet the criterion, will then input their availability parameters. This happens prior to the interviewee being notified of their candidacy. Unlike other systems, a real-time calendar is created, which allows all the interviewers and later, the interviewees to see available time slots.

The benefits of the current systems are that the recruiter is no longer required to communicate with each interviewer to confirm availability, educate them on what they will evaluate each candidate on, communicate with the candidates directly, alert candidates of their selection as a candidate, request availability from each candidate, and then to match the interviewer with the interviewee.

Further, some prior art systems and methods require the interviewer to intervene in the scheduling process when there is a conflict, or to accept or decline the appointment prior to scheduling. This can be impractical in many situations and prolong the interview scheduling process. The interviewers have entered their availability into the system up-front and there is no assumption made based on the interviewer's calendar as to availability. Prior art systems that have relied upon this technology were not useful because there were many false positives due to the interviewer's failure to maintain an accurate calendar.

The systems and methods of the present invention address these and other problems.

### SUMMARY

In one object, a scheduling system and method for producing a multi-candidate interview schedule is described herein, the system having a computer, a memory, a central processing unit and display in communicable attachment to each other. The system includes an interface adapted to accept at least one configuration parameter from at least one user into the memory, wherein the at least one configuration parameter is entered manually by the least one user, and the at least one configuration parameter is adapted to be accessed by the central processing unit. The central processing unit comprises means for creating a programmatic logic table based upon the configuration parameters, in electronic communication with the memory. The programmatic logic table is adapted to accept at least one specific data defined by the configuration parameters into a plurality of data cells, each including a single data type, the data type including at least one of candidate pool data, interview stage data, interview time data, hiring window data, and interviewer pool data. Each data cell has a unique compatibility marker attached thereto, which are configured for specified compatibility with each other based upon the configuration parameters. The means for creating a programmatic logic table is specifically adapted to accept the specific data directly from a user, but not from a stored memory source. The system further includes a means for associating the data using the compatibility markers to produce a real-time calendar, the real-time calendar is unique to the employment opening and is adapted to produce an output that includes a plurality of time blocks, which indicate the total amount of time required for a complete candidate pool to be interviewed by an at least one interviewers from the interview pool data at times pre-specified by the at least one interviewer in accordance with the configuration parameters. A notification means is also included, which is adapted to alert the plurality of interviewer of the creation of the real-time calendar and to alert a plurality of interviewees from the candidate pool of the creation of an updated real-time calendar. A means for accepting interviewer availability data from the plurality of invited interviewers and associating the data with the data within the programmatic logic table is also included. The association is based upon the compatibility markers to produce an updated real-time calendar. The invention further comprises means for accepting candidate scheduling data from the candidate pool after the candidate pool has been notified of the creation of an updated real-time calendar. The programmatic logic table is adapted to match the candidates with the interviewers to produce a completed interview schedule that includes a plurality of time blocks indicating the total amount of time required for a complete candidate pool to be interviewed by an at least one interviewer from the interview pool data at times pre-specified by the at least one interviewer in accordance with the configuration parameters. The interface is adapted to display the real-time calendar to the at least one interviewer, but not the candidate pool, and to display the updated real-time calendar to at least one user.

In another object, a method for simultaneously scheduling multiple interviewers with multiple candidates is also described. The method includes presenting, by an interview scheduling system for producing a multi-candidate interview schedule, the system having a computer having a memory, central processing unit and an interface in communicable attachment to each other, receiving at least one configuration parameter directly from at least one user into the memory by an interface adapted to accept the parameters, wherein the at least one configuration parameter is entered manually by the least one user, and the at least one configuration parameter is adapted to be accessed by the central processing unit; creating, by the central processing unit, a programmatic logic table based upon the configuration parameters, the programmatic logic table adapted to accept at least one specific data defined by the configuration parameters into a plurality of data cells, each including a single data type, the data type including at least one of candidate pool data, interview stage data, interview time data, hiring window data, and interviewer pool data, each data cell having unique compatibility markers attached thereto, the markers being configured for specified compatibility with each other based upon the configuration parameters, associating, by the programmatic logic table, the data using the compatibility markers to produce a real-time calendar, the real-time calendar being unique to the employment opening and the real-time calendar adapted to produce an output that includes a plurality of time blocks indicating the total amount of time required for a complete candidate pool to be interviewed by an at least one interviewers from the interview pool data at times pre-specified by the at least one interviewer in accordance with the configuration parameters; notifying the plurality of interviewer of the creation of the real-time calendar; accepting interviewer availability data from the plurality of interviewers, associating the interviewer availability data within the programmatic logic table, based upon the compatibility markers, to produce an updated real-time calendar, notifying the plurality of interviewees from the candidate pool of the creation of an updated real-time calendar; accepting candidate scheduling data from the candidate pool after the candidate pool has been notified of the creation of an updated real-time calendar, associating the candidate scheduling data within the programmatic logic table, based upon the compatibility markers, to produce a complete multi-candidate, multi-interviewer interview schedule for a position; and presenting the real-time calendar to at least one interviewer, but not the candidate pool, and wherein the interface is adapted to display the updated real-time calendar to at least one user, wherein the programmatic logic table is adapted to associate the candidates with the interviewers to produce a complete multi-candidate, multi-interviewer interview schedule that includes a plurality of time blocks indicating the total amount of time required for a complete candidate pool to be interviewed by an at least one interviewer from the interview pool data at times pre-specified by the at least one interviewer in accordance with the configuration parameters.

### BRIEF DESCRIPTION OF THE DRAWINGS

FIGS. 1-4 illustrate the user interface of the invention from the perspective of a recruiter user.

### DETAILED DESCRIPTION

In one embodiment of the invention, a scheduling system and method for producing a multi-candidate interview schedule is described. The system includes a computer, a memory, a central processing unit and display in communicable attachment to each other. The system includes an interface adapted to accept at least one configuration parameter from at least one user into the memory, wherein the at least one configuration parameter is entered manually by the least one user, and the at least one configuration parameter is adapted to be accessed by the central processing unit. The central processing unit comprises means for creating a programmatic logic table based upon the configuration parameters, in electronic communication with the memory. The programmatic logic table is adapted to accept at least one specific data defined by the configuration parameters into a plurality of data cells, each including a single data type, the data type including at least one of candidate pool data, interview stage data, interview time data, hiring window data, and interviewer pool data. Each data cell has a unique compatibility marker attached thereto, which are configured for specified compatibility with each other based upon the configuration parameters.

The means for creating a programmatic logic table is specifically adapted to accept the specific data directly from a user, but not from a stored memory source. If the data were pulled from an existing calendar, the problems associated with not keeping up to date calendars would still exist. The system further includes a means for associating the data using the compatibility markers to produce a real-time calendar, the real-time calendar is unique to the employment opening and is adapted to produce an output that includes a plurality of time blocks, which indicate the total amount of time required for a complete candidate pool to be interviewed by an at least one interviewers from the interview pool data at times pre-specified by the at least one interviewer in accordance with the configuration parameters. A notification means is also included, which is adapted to alert the plurality of interviewer of the creation of the real-time calendar and to alert a plurality of interviewees from the candidate pool of the creation of an updated real-time calendar. A means for accepting interviewer availability data from the plurality of invited interviewers and associating the data with the data within the programmatic logic table is also included.

Some prior art systems and methods require the interviewer to intervene in the association or scheduling process when there is a conflict in the interviewer's schedule, or to accept or decline the time block prior to actual scheduling. This can be impractical in many situations and prolong the interview scheduling process. The systems and methods of the invention avoid this problem by customizing the association process through data markers configured by the recruiter. The interviewers have entered their availability into the system up-front and there is no assumption made based on the interviewer's calendar as to availability. Prior art systems that have relied upon this technology were not useful because there were many false positives due to the interviewer's failure to maintain an accurate calendar.

The associations are based upon the compatibility markers to produce an updated real-time calendar. As used herein, the term “association” means to match or pair at least two data. The invention further comprises means for accepting candidate scheduling data from the candidate pool after the candidate pool has been notified of the creation of an updated real-time calendar.

The programmatic logic table is adapted to match the candidates with the interviewers to produce a completed interview schedule that includes a plurality of time blocks indicating the total amount of time required for a complete candidate pool to be interviewed by an at least one interviewer from the interview pool data at times pre-specified by the at least one interviewer in accordance with the configuration parameters. The interface is adapted to display the real-time calendar to the at least one interviewer, but not the candidate pool, and to display the updated real-time calendar to at least one candidate so that they may select interview sessions that are available and appropriate for them.

The calendars produced in accordance with the invention, are real-time, interactive calculators that will simplify how interviews are scheduled. The calendars reduce the amount of human resources necessary to schedule interviews from days to minutes. The recruiter simply enters configuration data into the system. As used herein, “configuration parameters” are a plurality of configuration data. The system accepts the data and produces a programmatic logic table, based on the parameters therein.

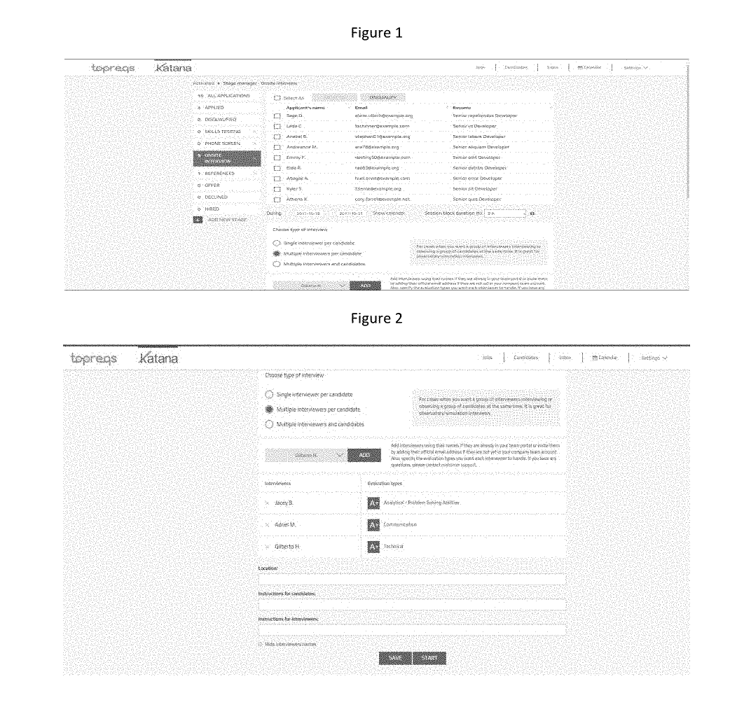

The configuration data may be any data that is useful in scheduling interviews. In certain embodiments, and with reference to FIG. 1, the configuration data is interview stage data. In specific embodiments, the interview data is at least one of phone screen stage, on-site interview stage data, etc. In other embodiments, the configuration data is at least one of, interview pool, or list of interviewers, applicant pool, or list of candidates, evaluation type, interview blocks, pairing types, or interview time frame. Interview time frame also means “interview window.” This the beginning of the interview period and the deadline for ending the interview process. Each schedule and real-time calendar will be created differently based on the configuration data input by a recruiter. The data will inform the programmatic logic table, which will generate time blocks and later perform the associations that will result in the interviews.

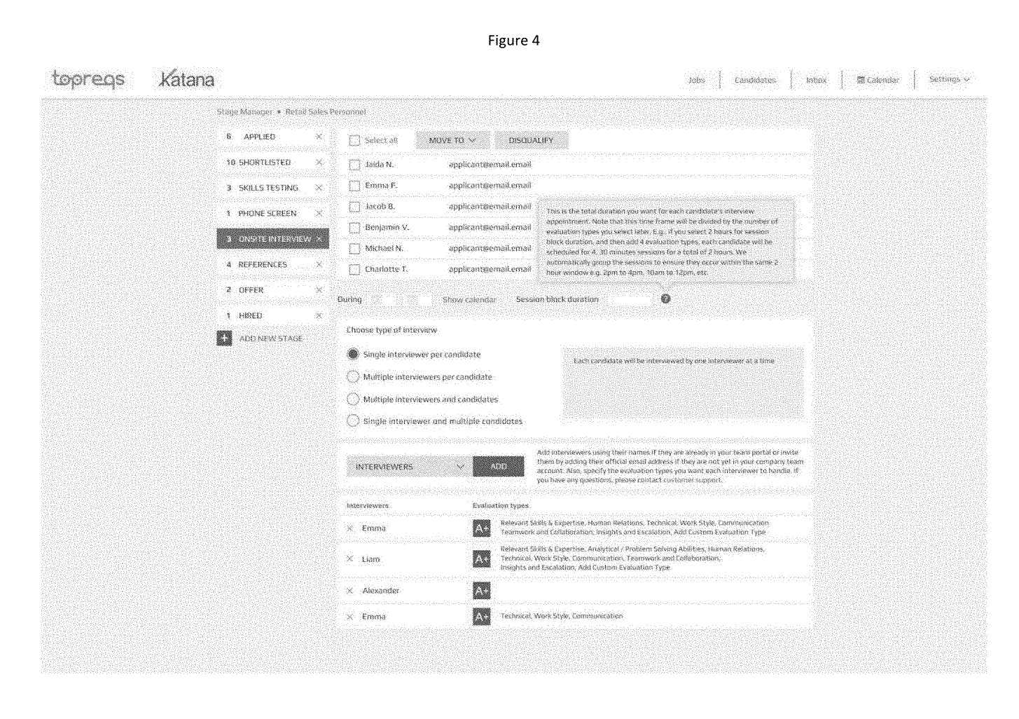

With reference to FIGS. 2 and 4, and in various embodiments of the invention, pairing types for the interview include one of single interviewer per candidate, multiple interviewers with multiple candidates, and multiple interviewers with a single candidate. The logic table will automatically mark the cells dedicated to interviewers or interviewees according to pairing type. Associations for interview blocks will be generated accordingly. This is of great benefit during the interviewing process because it's often difficult to calculate how many hours should be allocated to each session when there are either multiple candidates, or multiple interviewers necessary for a single session or interview block. In specific embodiments of the invention where there are multiple interviewers and multiple candidates required in a single session, the programmatic logic table will prevent both groups from selecting specific interview blocks. The logic table will associate all candidates and recruiters to a single interview block in accordance with the configuration data input by the recruiter. In this embodiment, both candidates and interviewers will all be notified of the scheduled interview block, without the consideration of availability.

In the specific embodiment of the invention wherein single interviewers are associated with multiple candidates, one interviewer's available time slots are associated with all candidates.

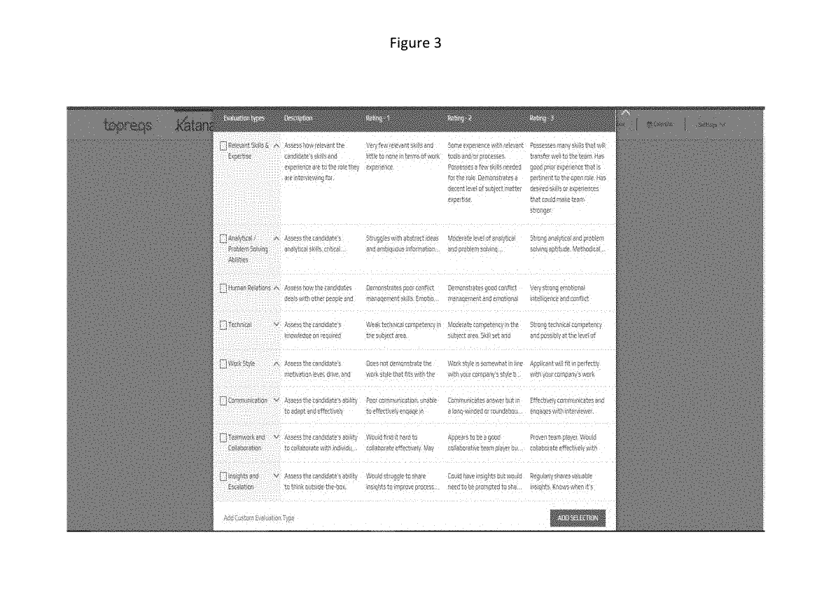

With reference to FIG. 3, and in specific embodiments of the invention, the evaluation type includes at least one of analytical, human relations, problem solving, work style, or communication and is associated with each interviewer.

In accordance with the invention, once the logic table is configured in accordance with the configuration data input by the recruiter, the system notifies the interviewers that they may input their availability within the parameters of the configuration data. The system then creates a real-time calendar that may be viewed by all interviewers. The calendar includes all open time slots for interviews. The time slots are based upon the configuration data. The time window is also based on the configuration data. In certain embodiments of the invention, the system will notify the interviewer of the type of evaluation for which they are responsible.

In embodiments of the invention where the interviewer evaluation type is one of the configuration data, the system will accept at least one interviewer evaluation type. The marker for the cells association with interviewer evaluation type will enable the logic table to match interviewers with certain evaluation types with candidates who need that type of evaluation. In certain embodiments, multiple interviewers are assigned to a single evaluation type.

In certain embodiments, the logic table always checks the number of unique evaluation types, then sets that as the required number of evaluation types for each interview block duration by markers the requisite number and type of cell accordingly. In these embodiments, no candidate should interview on just two evaluation types when the configuration data required three.

Multiple Examples are presented showing various examples of the system. The examples represent specific embodiments of the invention, and are not meant to be limited. The examples are as follows:

### Example 1

Joe—assigned to Analytical

Michael—assigned to Human Relations

Sam—assigned to Communication

In this Example, there are 20 candidates for a particular position, and 40 hours are required to interview the candidate pool. Since the interview block duration is 2 hours, each of them must be available for the same 2 hour blocks in order for it to count towards the required 40 hours availability. The reason for this requirement is because we don't want a candidate doing one evaluation type at 2:00 pm and then their next evaluation type is at 4 pm the following day. We want to make sure the next evaluation will be at 2:40 pm that same day, then 3:20 pm that same day. This way one candidate will do all of his/her interviews within the same 2-hour time frame.

### Example 2

Assume candidate names are candidate 1 and candidate 2 it will look as follows:

Candidate 1 selects interview block (2 pm to 4 pm) 120 minutes divided by 3 evaluation types=40 mins per session as shown below.

Joe—2 pm (Analytical)—candidate 1

Michael—2:40 pm (Human Relations)—candidate 1

Sam—3:20 pm (Communication)—candidate 1

Candidate 2 selects interview block (10 am to 12 pm) 120 minutes divided by 3 evaluation types=40 mins per session as shown below.

Joe—10 am (Analytical)—candidate 2

Michael—10:40 am (Human Relations)—candidate 2

Sam—11:20 am (Communication)—candidate 2

The Examples illustrate why overlapping availabilities of the interviewers must be used to calculate their eligible blocks when adding for the 40 hours required in the example of 20 candidates for 2 hours each. The system thereby ensures each candidate's appointment is determined by duration block as opposed to by each 40-minute evaluation type session since they will only make one trip to the interview site.

In one exemplary embodiment of the invention, once interviewers have met the required minimum hours to accommodate total number of candidates (e.g. 40 hours), the system notifies candidates and accepts availability information for their interview. The candidate must pick based on session duration blocks not based on evaluation types as such, the candidates will simply see appointment (session duration block) options. Once a candidate selects an appointment, the system, via the programmatic logic table, will then send an email to the interviewers in that interview block duration confirming the appointment, send another email to the candidate confirming the appointment, and send a copy email to the recruiter notifying the recruiter of the appointment confirmation.

In another exemplary embodiment of the invention, whereby multiple interviewers are interviewing a single candidate, the methods described immediately above are the same, except, once a recruiter selects this pairing option, and the system accepts the associated configuration data, the system will accept and request interview pool data, or the number of applicants, per evaluation type. For example, if the recruiter states 3 interviewers per evaluation type, the recruiter will be required to add at least 9 interviewers (3 interviewers each×3 evaluation types). Since the interview block duration is still 2 hours, the math won't change there.

However, this will mean that the only interview time blocks that will count towards the required 40 hours are the time blocks in which all 9 interviewers are available for the same 2 hours period. Naturally, in real life, usually when an employer wants to do group interviews they probably will just do one evaluation type and call it general so we are not likely to see group interviews like above. But the programmatic logic table of the invention accommodates these scenarios in case they happen.

The system will accept the interviewer's availability data, so long as it is not in conflict with the configuration data. For example, if an interviewer will be unavailable during the hiring window, the system will not allow the interviewer to input dates outside of the hiring window.

In certain other exemplary embodiments, once the schedule is set, candidates are notified by the system of available time slots for their interviews. The system will accept availability date from the candidates, and based on the markers associated with the configuration table, associate at least one candidate and at least one interviewer. The programmatic logic table will automatically associate candidates and interviewers with each other where multiple candidates and/or multiple interviewers are available during the same time session or block. As used herein, session is used synonymously with time block, interview session, block, or interview block.

As such, the system of the invention goes much further than facilitating email communication between interviewers, recruiters and interviewees. The system automates pairing processes that are dynamic and unique to each position using the unique programmatic logic table that adapts the system for each position or job based on the unique needs of the position input by a recruiter. The system avoids pains related to automated unsatisfactory association of interviewers and candidates by systems who simply match based on availability shown on calendars. If time availability is the only consideration, the evaluation type, and job stage aren't considered, which greatly dampen the usefulness of the association and resulting interview. Each candidate should be specifically matched with the interviewer, or other candidates, based on the parameters determined by the recruiter. Availability is never the only consideration when pairing job candidates with interviewers.

In these particular embodiments, the associations are instantaneous, as the system will not accept confirmations or request confirmations from any user at this stage on an updated real-time calendar. This is primarily attractive to organizations that do not have integrated calendars.

While in preferred embodiments of the invention, the interviewer's schedule is the primary driver, in certain specific embodiments of the invention, the system allows the candidates to also enter their availability in a calendar upfront and then do the many to many matching once both candidates and interviewers have filled their availability.

The system automatically displays the association via its interface on the real-time calendar. However, it should be noted that the interface displays different information based on user type.

The interface is adapted to restrict the candidate's display to only the candidate interview block or the candidate's schedule. The candidate may or not, based upon the configuration data input by the recruiter, see the interviewer's name or other information.

The systems and methods of the invention are illustrative of various preferred embodiments of the invention. It can be understood that those of skill in the art would make various modifications and adjustments without departing from the spirit and scope of this invention. All modifications and adjustments to the methods and systems disclosed herein are anticipated and expected.

All prior art references recited herein are incorporated by reference as if fully disclosed herein.

What is claimed:

1. An interview scheduling system for producing a multi-candidate interview schedule, the system having a computer having a memory, central processing unit and a display in communicable attachment to each other, the system comprising:
an interface adapted to accept at least one configuration parameter from at least one user into the memory, wherein the at least one configuration parameter is entered manually by the least one user, and the at least one configuration parameter is adapted to be accessed by the central processing unit;
the central processing unit comprising means for creating a programmatic logic table based upon the configuration parameters, in electronic communication with the memory,
the programmatic logic table adapted to accept at least one specific data defined by the configuration parameters into a plurality of data cells, each including a single data type, the data type including at least one of candidate pool data, interview stage data, interview time data, hiring window data, and interviewer pool data,
each data cell having unique compatibility markers attached thereto, the markers being configured for specified compatibility with each other based upon the configuration parameters,
wherein the means for creating a programmatic logic table is specifically adapted to accept the specific data directly from a user, and the means for creating a programmatic logic table is not adapted to retrieve the specific data from the memory;
a means for associating the data using the compatibility markers to produce a real-time calendar, the real-time calendar being unique to the employment opening and the real-time calendar adapted to produce an output that includes a plurality of time blocks indicating the total amount of time required for a complete candidate pool to be interviewed by an at least one interviewers from the interview pool data at times pre-specified by the at least one interviewer in accordance with the configuration parameters;
notification means adapted to alert the plurality of interviewer of the creation of the real-time calendar and to alert a plurality of interviewees from the candidate pool of the creation of an updated real-time calendar;
a means for accepting interviewer availability data from the plurality of invited interviewers and associating the data with the data within the programmatic logic table, based upon the compatibility markers to produce an updated real-time calendar; and
a means for accepting candidate scheduling data from the candidate pool after the candidate pool has been notified of the creation of an updated real-time calendar,
wherein the programmatic logic table is adapted to match the candidates with the interviewers to produce a completed interview schedule that includes a plurality of time blocks indicating the total amount of time required for a complete candidate pool to be interviewed by an at least one interviewer from the interview pool data at times pre-specified by the at least one interviewer in accordance with the configuration parameters,
wherein the interface is adapted to display the real-time calendar to the at least one interviewer, but not the candidate pool, and wherein the interface is adapted to display the updated real-time calendar to at least one user.

2. The system of claim 1, wherein the programmatic logic table is adapted to match an at least one interviewer with a plurality of interviewees.

3. The system of claim 1, wherein the programmatic logic table is adapted to match a plurality of interviewees with one interviewer.

4. The system of claim 1, wherein the interview stage information is at least one of phone screen stage or on sight interview stage.

5. The system of claim 1, wherein the candidate availability information is based upon interview stage.

6. The system of claim 1, wherein the interviewer pool information is the number of interviewers required to interview each candidate.

7. The system of claim 1, wherein the hiring window includes an opening date and a closing date and the programmatic logic table is configured to restrict interviews on or between the opening and closing date.

8. The system of claim 1, the data types further include interview evaluation type.

9. The system of claim 8, wherein the evaluation type includes at least one of analytical, human relations, problem solving, work style, or communication.

10. A method for simultaneously scheduling multiple interviewers with multiple candidates, the method comprising:
presenting, by an interview scheduling system for producing a multi-candidate interview schedule, the system having a computer having a memory, central processing unit and an interface in communicable attachment to each other;
receiving at least one configuration parameter directly from at least one user into the memory by an interface adapted to accept the parameters, wherein the at least one configuration parameter is entered manually by the least one user, and the at least one configuration parameter is adapted to be accessed by the central processing unit;
creating, by the central processing unit, a programmatic logic table based upon the configuration parameters,
the programmatic logic table adapted to accept at least one specific data defined by the configuration parameters into a plurality of data cells, each including a single data type, the data type including at least one of candidate pool data, interview stage data, interview time data, hiring window data, and interviewer pool data,
each data cell having unique compatibility markers attached thereto, the markers being configured for specified compatibility with each other based upon the configuration parameters,
associating, by the programmatic logic table, the data using the compatibility markers to produce a real-time calendar, the real-time calendar being unique to the employment opening and the real-time calendar adapted to produce an output that includes a plurality of time blocks indicating the total amount of time required for a complete candidate pool to be interviewed by an at least one interviewers from the interview pool data at times pre-specified by the at least one interviewer in accordance with the configuration parameters;
notifying the plurality of interviewer of the creation of the real-time calendar;
accepting interviewer availability data from the plurality of interviewers;
associating the interviewer availability data within the programmatic logic table, based upon the compatibility markers, to produce an updated real-time calendar;
notifying the plurality of interviewees from the candidate pool of the creation of an updated real-time calendar;
accepting candidate scheduling data from the candidate pool after the candidate pool has been notified of the creation of an updated real-time calendar,
associating the candidate scheduling data within the programmatic logic table, based upon the compatibility markers, to produce a complete multi-candidate, multi-interviewer interview schedule for a position; and
presenting the real-time calendar to at least one interviewer, but not the candidate pool, wherein the interface is adapted to display the updated real-time calendar to at least one user, and wherein the programmatic logic table is adapted to associate the candidates with the interviewers to produce a complete multi-candidate, multi-interviewer interview schedule that includes a plurality of time blocks indicating the total amount of time required for a complete candidate pool to be interviewed by an at least one interviewer from the interview pool data at times pre-specified by the at least one interviewer in accordance with the configuration parameters.

11. The method of claim 10, wherein the programmatic logic table is adapted to match an at least one interviewer with a plurality of interviewees.

12. The method of claim 10, wherein the programmatic logic table is adapted to match a plurality of interviewees with one interviewer.

13. The method of claim 10, wherein the interview stage information is at least one of phone screen stage or on sight interview stage.

14. The method of claim 10, wherein the candidate availability information is based upon interview stage.

15. The method of claim 10, wherein the interviewer pool information is the number of interviewers required to interview each candidate.

16. The method of claim 10, wherein the hiring window includes an opening date and a closing date and the programmatic logic table is configured to restrict interviews on or between the opening and closing date.

17. The method of claim 10, the data types further include interview evaluation type.

18. The method of claim 17, wherein the evaluation type includes at least one of analytical, human relations, problem solving, work style, or communication

19. The method of claim 10 further comprising accepting and storing a candidate score.
